(19) United States
(12) Patent Application Publication
(10) Pub. No.: US 2009/0225231 A1
(43) Pub. Date: Sep. 10, 2009

(54) SOFTWARE UPDATING BY MEANS OF A REMOTE CONTROL

(76) Inventor: Ercan Sozeri, Izmir (TR)

Correspondence Address: VENABLE, CAMPILLO, LOGAN & MEANEY, P.C., 1938 E. OSBORN RD, PHOENIX, AZ, 85016-7234, US

(21) Appl. No.: 11/813,096

(22) PCT Filed: Dec. 21, 2005
(86) PCT No.: PCT/IB2005/054352

§ 371 Date: Mar. 21, 2008

(30) Foreign Application Priority Data
Dec. 29, 2004 (TR) 2004/03708

(51) Int. Cl. H04N 5/44

(52) U.S. Cl. 348/734; 725/152; 348/E05.096

(57) ABSTRACT

This invention relates to a method of updating software of target devices such as televisions with remote control software updating features, VCD/DVD players, STB, DVD and Video recorders by means of a remote control and a remote control which operates in accordance with this method

### TECHNICAL FIELD

This invention relates to a method of updating software of target devices, such as televisions, VCD/DVD players, STB, DVD and Video recorders with remote control software updating features, by means of a remote control and a remote control device which operates in accordance with this method.

### PRIOR ART

In the state of art, various applications regarding software updating by means of a remote control are known.

The United States patent application U.S. Pat. No. 4,623,887, which is one of the applications known in the art, discloses a re-adjustable remote control which comprises a microprocessor and an infrared receiver and which receives, stores and repeats remote control codes sent by another infrared transmitter.

Another application known in the art is disclosed in the Canadian patent application CA2271555. This application relates to a method used in cable television systems and a remote control device which operates in accordance with this method.

Whereas, in the Canadian patent application CA2326555, a remote control with up-gradeable features is disclosed. The system in this patent application comprises a remote control device having a microprocessor and a memory connected to the microprocessor for storing software and codes necessary for controlling external devices.

Another application relates to smart remote control devices and it is disclosed in the Chinese patent application CN1437167. The said smart remote control system comprises a key pad, a sending module which can be characterized as a microprocessor, a data receiving module, a memory module and a screen module whereon information is displayed and it is particularly used in household devices for software updating.

In the current state of art, software updating comprises the following steps. The software to be loaded to the device is stored in the computer. A cable is used to enable communication between the computer and the device. The type of the cable varies according to the type of communication (for instance, RS232, parallel connection cable and USB cable etc.). An appropriate connector must be present on the device for connecting these cables. A small software is present inside the device which transfers the software received from the computer to areas where it will not be lost and the data received from the computer are saved in certain areas respectively. The cable is removed when the process is completed and the new software is activated by restarting the device.

However, in these applications, a computer and special cable systems are necessary for updating the software of TV's, STB's, DVD's and target devices as such which operate with a remote control. This situation is a factor which increases costs. Furthermore, the excess amount of time needed for updating the software of more than one device simultaneously in production plants is another major disadvantage. Moreover, the devices must be transported to a technical service or a computer must be set alongside the devices for updating their software. And this is a major disadvantage in terms of time and a factor which increases costs.

### BRIEF DESCRIPTION OF THE INVENTION

The object of this invention is to realize a method for updating the software of televisions, VCD/DVD players, DVD recorders and devices as such by means of a remote control. In this way, a more economic way of updating more than one device simultaneously with the latest software without needing a computer and special cable systems is ensured. Furthermore, the user no longer has to go to the technical service for correcting manufacture defects of the software or for updating the features of the product. In this way, the user will be able to save considerable amount of time and costumer satisfaction will increase.

The method utilized in the remote control which is realized in order to attain the objects of this invention comprises, fundamentally, the steps of programming the permanent memory (ROM memory-Flash) on the remote control by using the necessary connection points (particularly RS-232) via computer; bringing the remote control alongside the target device the software of which is to be updated; sending the new software as a remote control code by means of a special key (transfer key) situated on the remote control, the target devices, which have capabilities to detect these codes, saving the software inside the temporary memory; controlling whether the target device has loaded the correct software, if it is the correct software the device copying the software to its permanent memory from the temporary memory; and activating the new software by turning on the device for the first time after updating the software of the target device.

### DETAILED DESCRIPTION OF THE INVENTION

The method and the remote control, which operates in accordance with this method, realized in order to attain the objects of this invention are illustrated in the accompanying figures, wherein;

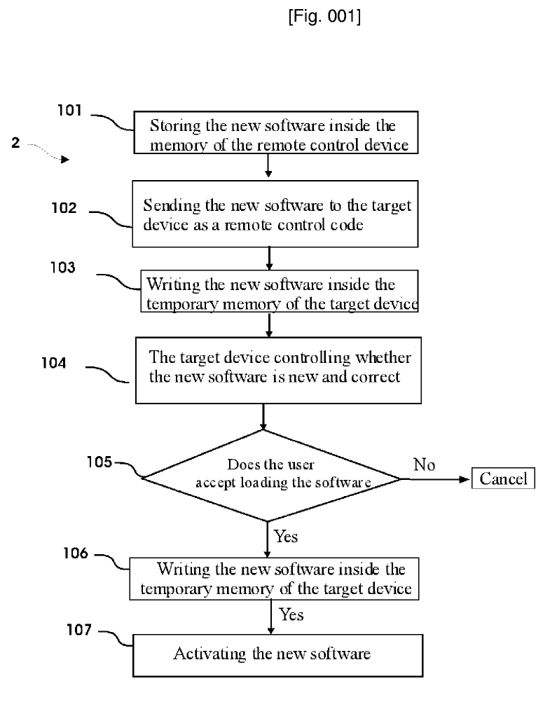

FIG. 1—is a flow chart of the method which is subject of the invention;

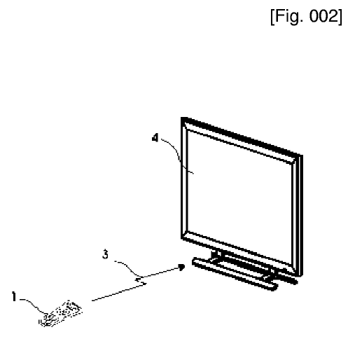

FIG. 2—is a schematic view of the mechanism wherein the method of the invention is implemented.

The components in the figures have each been numbered corresponding to the following:
1. Remote control device
2. Method
3. Software
4. Target device

The remote control device (1) is used for controllable devices (4) such as televisions, VCD/DVD players, STB, DVD and Video recorders. The said remote control device (1) comprises preferably a key pad, a transmitter which sends codes to the target for controlling the devices, a memory device programmed by means of computer wherein the new software (3) is stored and a transmission key for sending the remote control codes of the new software to the target device.

With the method (2) of the invention, the renewed software (3) for the target device (4) is stored inside the permanent memory of the remote control device (1) via computer. Next, the remote control device (1) is brought alongside the target device (4) and the renewed software (3) which is loaded to the memory of the remote control is transferred to the temporary memory of the target device (4) as a remote control code. The new software which is transferred is controlled by the target device (4) whether it is correct and new and, if it is correct and new, it is stored inside the permanent memory of the target device (4). The new software is activated when the device is turned on for the first time after updating.

The method realized in order to attain the objects of this invention comprises, in its most basic form, the steps of;
storing the new software inside the memory of the remote control device (101),
sending the new software to the target device as a remote control code (102),
writing the new software inside the temporary memory of the target device (103),
the target device controlling whether the new software is correct or not (104),
if the software is the correct software, it is stored inside the permanent memory of the target device(106).

In another embodiment of the invention, the method (2) of the invention also comprises the step of notifying the user that the software has been found and asking his/her approval (105) when a new software (3) concerning the target device has been detected. In this embodiment, the software is loaded to the television only when the user accepts it.

Yet in another embodiment of the invention, the process of loading is realized in exchange of a certain fee.

In one of the embodiment of the invention, the software (3) is activated when the device is turned for the first time after being updated; however, in other embodiments of the invention, the software (3) can be activated right after it has been updated.

According to the method (2) of the invention, the target device (4) comprises a processor (not shown) which is to realize the method (2) and a temporary and permanent memory device (not shown) wherein the new software (3) is to be loaded.

### INDUSTRIAL APPLICABILITY

If there is an error in the software loaded to the target device, which has a feature of software updating by means of a remote control, by using the method of the invention, the new software which is capable of correcting this error can be loaded by using a remote control device without having to take the device to technical service.

It is possible to develop wide range of embodiments for the television which is the subject of the invention without departing from this main concept and the television of the invention is principally as disclosed in the claims and it cannot be restricted with the examples stated herein.

1. A method comprising the steps of; storing the new software inside the memory of the remote control device (101); sending the new software to the target device as a remote control code (102); writing the new software inside the temporary memory of the target device (103); the target device controlling whether the new software is correct or not (104); if the software is new and correct, writing the new software inside the permanent memory of the target device (106), which are applied to target devices having features of software updating by means of a remote control.

2. A method (2) defined in claim 1 characterized with the step of notifying the user that the software has been found and asking his/her approval (105), before the download of software, when a new and correct software (3) concerning the target device (4) has been detected.

3. A method (2) as defined in claim 1 to 2 characterized with the step of activating the software when the device is turned on for the first time after the software is written inside the memory.

4. A remote control device (1) wherein a method as defined in any one of the preceding claims is applied.

5. A remote control device (1) as defined in claim 4 comprising a processor which realizes the method (2) described in claims 1 to 3.

6. A remote control device (1) as defined in claims 4 and 5 comprising a memory device wherein the new software is to be loaded.
